(19) United States
(12) Patent Application Publication
(10) Pub. No.: US 2010/0265619 A1
(43) Pub. Date: Oct. 21, 2010

(54) MAGNETIC STORAGE MEDIUM AND MAGNETIC STORAGE DEVICE

(75) Inventors: Koji MIYAKE, Hachioji-shi (JP); Takahiro IMAMURA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/764,719

(22) Filed: Apr. 21, 2010

(30) Foreign Application Priority Data
Apr. 21, 2009 (JP) 2009-102557

(51) Int. Cl. G11B 5/60; G11B 5/82

(52) U.S. Cl. 360/234.3; 360/135; G9B/5.293; G9B/5.229

(57) ABSTRACT

According to an embodiment, a magnetic storage medium includes a data area in and from which a magnetic head on a magnetic head slider records and reproduces data, the data area including an innermost peripheral radius Rid [m] and an outermost peripheral radius Rod [m]. If a rotational speed during recording and reproduction of the data is RPS [rps], waviness of the storage medium with a wavelength in a range between λ1 (=2×π×Rid×RPS/300,000) and λ2 (=2×π×Rod×RPS/100,000) is set to at most 0.05 nm in terms of a standard deviation value (sigma value).

### CROSS-REFERENCE TO RELATED APPLICATIONS

This application is based upon and claims the benefit of priority from Japanese Patent Application No. 2009-102557, filed Apr. 21, 2009, the entire contents of which are incorporated herein by reference.

### BACKGROUND

1. Field

An embodiment relates to a magnetic storage medium and a magnetic storage device.

2. Description of the Related Art

In general, a magnetic disk device comprises a rotating magnetic disk and a magnetic head slider supported by a suspension. The magnetic head slider comprises a magnetic head (recording and reproducing element), and reads and writes data from and to an appropriate data area of the magnetic disk, while moving relative to the magnetic disk. In such a magnetic disk device, for increased recording density, the distance between the magnetic disk and the magnetic head slider, that is, the flying height (FH) of the magnetic head slider from the magnetic disk, is preferably reduced.

Factors hindering the reduction in FH include the concavo and convex shape (waviness) of the surface of the magnetic disk. Waviness with a wavelength of at least several hundred micrometers is known to vary the distribution of pressure generated between the magnetic disk and the magnetic head slider, thus varying FH. Furthermore, waviness with a wavelength of at most about 10 μm is called roughness. Moreover, waviness with a wavelength of between about several tens of micrometers and several hundred micrometers is called microwaviness. For example, as disclosed in IEEE TRANSACTIONS ON MAGNETICS, voL. 38, No. 1, January 2002, “The Effects of Disk Morphology on Flying-Height Modulation: Experiment and Simulation” Brian H. Thornton, D. B. Bogy and C. S. Bhatla, the microwaviness is known to cause an air film generated by the magnetic head slider to resonate.

Furthermore, Jpn. Pat. Appln. KOKAI Publication No. 2005-203084 discloses a technique to increase the magnitude of waviness including the region of microwaviness with a wavelength of at most 100 or 200 μm, while minimizing the magnitude of waviness with at least 100 or 200 μm, to suppress a variation in FH caused by adsorption friction and waviness with a large wavelength, thus reducing FH.

The resonance of the air film generated by the magnetic head slider may degrade signal recording and reproducing characteristics and promote the contact between the magnetic disk and the magnetic head slider. Thus, the microwaviness is desirably insignificant enough to prevent the air film generated by the magnetic head slider from resonating.

However, the resonance of the air film generated by the magnetic head slider may not be sufficiently suppressed simply by stereotypical control of waviness with only the geometric factors relating to the magnetic disk surface such as the wavelength of the waviness taken into account.

### BRIEF DESCRIPTION OF THE SEVERAL VIEWS OF THE DRAWINGS

FIG. 1 is an exemplary plan view showing the internal configuration of an HDD according to an embodiment;

FIG. 2 is an exemplary diagram schematically showing the configuration of a suspension and a head slider held by the suspension, the suspension and head slider both being included in the HDD;

FIG. 3A is an exemplary characteristic diagram showing the magnitude of waviness with a wavelength of about 10 μm in a magnetic disk with insignificant microwaviness and a magnetic disk with significant microwaviness;

FIG. 3B is an exemplary diagram showing the roughness (Ra) of waviness of a wavelength of at most about 10 μm in each of the magnetic disks in FIG. 3A;

FIG. 4 is an exemplary diagram showing the results of measurement of FH during resonance in magnetic disks with different magnitudes of microwaviness, with the rotational speed of each magnetic disk and the flying position of the head slider varied;

FIG. 5A is an exemplary diagram showing an impulse response from a head slider according to a comparative example;

FIG. 5B is an exemplary frequency characteristic diagram of vibration of the head slider according to the embodiment with FH reduced using an FH adjustment mechanism;

FIG. 6 is an exemplary diagram showing specific examples of Rid, Rod, and RPS; and

FIG. 7 is an exemplary diagram showing the relationship between the FH during resonance and the sigma value of waviness in the magnetic disk.

### DETAILED DESCRIPTION

Various embodiments will be described hereinafter with reference to the accompanying drawings. In general, according to one embodiment, there is provided a magnetic storage medium comprises a data area in and from which a magnetic head on a magnetic head slider records and reproduces data, the data area comprising innermost peripheral radius Rid [m] and an outermost peripheral radius Rod [m]. If a rotational speed during recording and reproduction of the data is RPS [rps], waviness of the storage medium with a wavelength in a range between λ1 (=2×π×Rid×RPS/300,000) and λ2 (=2×π×Rod×RPS/100,000) is set to at most 0.05 nm in terms of a standard deviation value (sigma value).

A magnetic storage medium and a magnetic storage device according to an embodiment will be described with reference to the drawings.

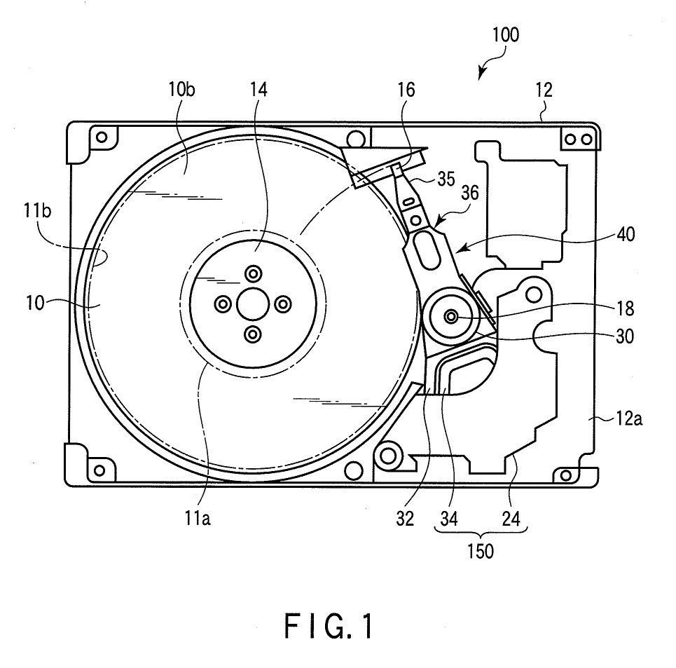

FIG. 1 shows the internal configuration of a hard disk drive (HDD) 100 serving as a magnetic storage device according to the embodiment. As shown in FIG. 1, the HDD 100 comprises a housing 12, a magnetic disk 10 serving as a magnetic storage medium, a spindle motor 14, and a head stack assembly (HSA) 40. The magnetic disk 10, spindle motor 14, and HAS 40 are accommodated in a space (accommodation space) inside the housing 12. In actuality, the housing 12 comprises a base 12a and a top cover. However, for convenience, FIG. 1 shows the HDD with the top cover removed.

The magnetic disk 10 comprises a recording surface on each side thereof and is rotated, by a spindle motor 14, around a rotating shaft of the spindle motor 14 at a high speed of between about 3,600 and about 15,000 rpm. An annular data area 10b is formed on the recording surface of the magnetic disk 10.

Both the front and back surfaces of the magnetic disk 10 may form recording surfaces. Furthermore, a plurality of magnetic disks 10 may be stacked on top of one another in the axial direction of the spindle motor 14.

The HSA 40 comprises a cylindrical housing section 30, a fork portion 32 fixed to the housing section 30, a voice coil 34 held on the fork portion 32, a carriage arm 36 fixed to the housing section 30, and a magnetic head slider 16 held on the carriage arm 36. As described above, if both the front and back surfaces of magnetic disk 10 form recording surfaces, a pair of carriage arms and a pair of magnetic head sliders are provided such that the carriage arms are vertically symmetric with respect to the magnetic disk 10 and such that the magnetic head sliders are also vertically symmetric with respect to the magnetic disk 10. Furthermore, if a plurality of magnetic disks are provided, the carriage arm and the magnetic head slider are provided for each recording surface of each magnetic disk.

A suspension 35 molded by, for example, punching a stainless plate or extruding an aluminum material is attached to the carriage arm 36. The magnetic head slider 16 is supported at the tip of the suspension 35.

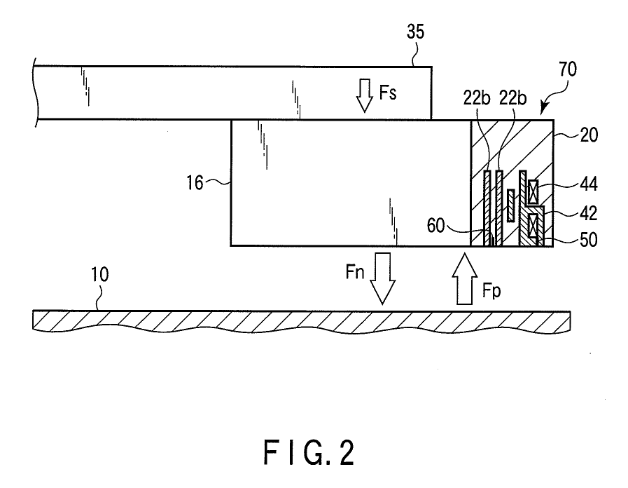

FIG. 2 schematically shows the configuration of the suspension 35 and the magnetic head slider 16 held by the suspension 35. As shown in FIG. 2, the magnetic head slider 16 comprises a recording and reproducing head (hereinafter simply referred to as a “head”) 70. The magnetic head 70 comprises an alumina section 20, and a read element 60 and a write element 50 both embedded in the alumina section 20. The alumina section 20 can be thermally deformed (expanded) and return to its original form.

The read element 60 is a magnetoresistive (MR) or a giant magnetoresistive (GMR) head configured to sense magnetic fields generated in a recording layer of the magnetic disk 10 to read information recorded on the magnetic disk 10. Shields 22a and 22b are provided in the alumina section 20 and the read element 60 is sandwiched between the shields 22a and 22b. The shields 22a and 22b are formed of permalloy (Ni—Fe alloy).

The write element 50 includes a magnetic pole 42 and a write coil 44 provided near the magnetic pole 42. The write element 50 records information on the magnetic disk 10 by using magnetic fields generated by the write coil 44 and the magnetic pole 42 to magnetize the recording layer in the magnetic disk 10.

A heater 26 is provided near the write coil 44. Upon receiving heat from the heater 26, members around the heater 26 are thermally deformed (thermally expanded). The thermal deformation causes the read element 60 and the write element 50 to project in a direction in which the elements 60 and 50 approach the surface of the magnetic disk 10. That is, in the present embodiment, the magnetic head 70 comprises a flying height (FH) adjustment mechanism (including the heater 26) configured to adjust the FH of the magnetic head slider 16.

As shown in FIG. 1, the HSA 40 is rotatably mounted in the housing 12 (rotatable around a Z axis) by a bearing member 18 provided in a central portion of the housing section 30. The voice coil 34 of the HSA 40 and a magnetic pole unit 24 fixed to the base 12a of the housing 12 constitute a voice coil motor (VCM) 150. The VCM 150 swings the HSA 40 around the bearing member 18. FIG. 1 shows the swinging path of the head slider 16 in a dot and dashed line.

In the HDD 100 configured as described above, with the magnetic head slider 16 flying over the magnetic disk 10, the magnetic head 70 writes and reads data to and from the magnetic disk 10. A recessed and protruding surface (air bearing surface) is formed on the bottom surface (which lies opposite the magnetic disk 10) of the magnetic head slider 16 so as to generate both a positive force (Fp) and a negative force (Fn) by means of an air flow resulting from rotation of the magnetic disk 10. That is, the magnetic head slider 16 is a negative pressure slider with improved flying characteristics. In the present embodiment, the positive force (Fp), the negative force (Fn), and the negative force (FS) exerted by the suspension 35 balance with one another (Fp=Fn+FS).

The negative pressure slider offers superior pressure reduction characteristics to magnetic head sliders configured to avoid the use of negative pressure. Specifically, in conventional magnetic head sliders, the two forces (Fp) and (Fs) are balanced (Fp=Fs). Thus, if the force Fp decreases consistently with the air pressure between the magnetic head slider and the magnetic disk, then Fs>Fp and the magnetic head and the magnetic disk come closer to or into contact with each other.

In contrast, in the negative pressure slider 16 according to the present embodiment, the force (Fp) is balanced with the force (Fn+Fs) as described above. Thus, the forces (Fp) and the force (Fn) simultaneously decrease consistently with the air pressure. This enables the amount of decrease in FH to be reduced. That is, the present embodiment serves to prevent the magnetic head slider 16 and the magnetic disk 10 from coming closer to or into contact with each other. In this case, the amount of decrease in FH can be more effectively reduced by setting the value of each of the forces (Fp) and (Fn) much larger than that of the force (Fs). An increase in the values of the forces (Fp) and (Fn) significantly increases the rigidity of an air film generated by the negative pressure slider. Specifically, the resonant frequency of the air film generated by the magnet head slider 16 can be set to, for example, at least 100 kHz.

However, an excessive reduction in force (Fs) may significantly degrade the impact resistance of the HDD 100. Furthermore, the forces (Fp) and (Fn) have an upper limit depending on the size of the magnetic head slider and the design of the air bearing surface. Thus, the air film generated by the magnetic head slider 16 has a resonant frequency of at most 300 kHz.

As described above, the magnetic head 70 comprises the FH adjustment mechanism with the heater 26. When the FH adjustment mechanism is used to set a small FH, the air film generated by the magnetic head slider 16 resonates significantly. In the description below, FH at which a resonance amplitude exceeds a predetermined threshold is defined as an FH during resonance.

The present inventors' experiments on the design of the magnetic disk 10 that utilizes the FH during resonance will be described.

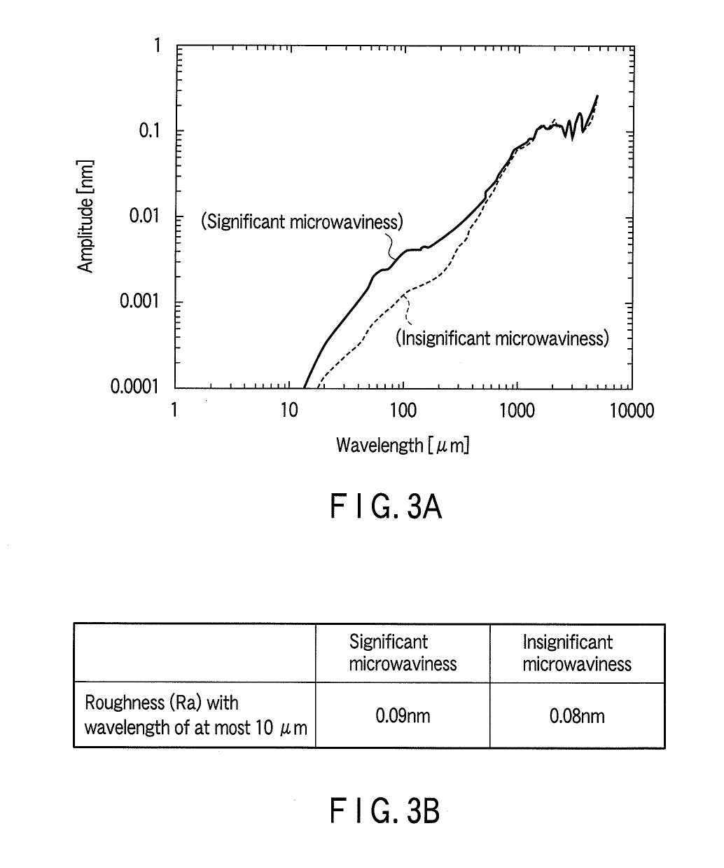

FIG. 3A is a graph showing the magnitude of waviness with a wavelength of at least 10 μm in each of a magnetic disk with insignificant microwaviness and a magnetic disk with significant microwaviness. FIG. 3B is a table showing the roughness (Ra) of waviness with a wavelength of at most 10 μm in each of the magnetic disks in FIG. 3A. As shown in FIGS. 3A and 3B, the magnetic disks vary in the magnitude of waviness in the wavelength region (between several tens of micrometers and several hundred micrometers) of microwaviness. On the other hand, the waviness in the other wavelength regions is almost the same for both disks.

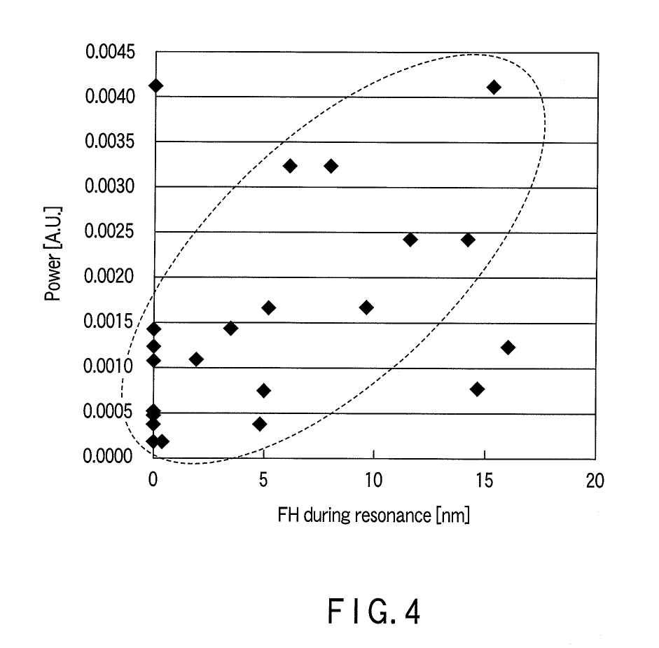

FIG. 4 shows the results of measurement of the FH during resonance in the magnetic disks 10 with different magnitudes of microwaviness, with the rotational speed of each of the magnetic disks 10 and the flying position (radial position) of the magnetic head slider 16 varied. A laser measuring instrument was used to measure the behavior of the magnetic head slider and to simultaneously measure the waviness of the magnetic disk. Furthermore, specifically, FIG. 4 shows the relationship between the FH during resonance and the height of waviness with a wavelength corresponding to a resonant frequency of 180 kHz. Here, the “height of waviness with a wavelength corresponding to a resonant frequency of 180 kHz” means the power value of power spectrum of waviness obtained at 180 kHz.

FIG. 4 indicates that the FH during resonance is correlated with the height of waviness with a wavelength corresponding to a resonant frequency of 180 kHz. That is, in order to suppress the resonance of the air film generated by the magnetic head slider, it is more effective to reduce microwaviness based on the rotational speed at which the magnetic disk 10 is used and the resonant frequency of the air film generated by the magnetic head slider 16 instead of blindly reducing microwaviness. In other words, the resonance of the air film generated by the magnetic head slider 16 cannot be sufficiently suppressed simply by stereotypically controlling waviness with only the geometric factors relating to the surface of the magnetic disk 10 such as the wavelength of waviness taken into account.

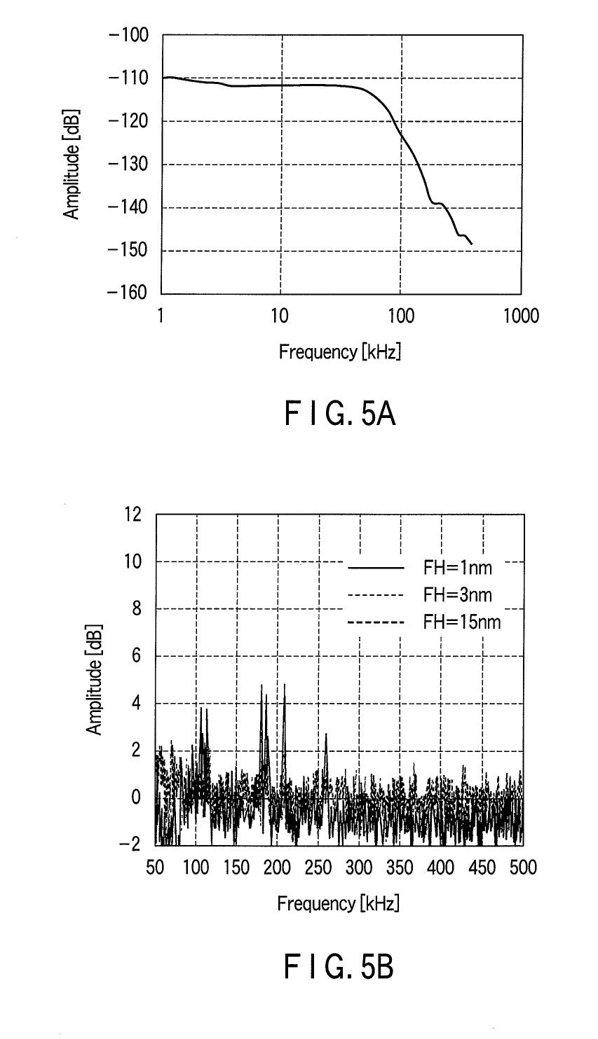

FIG. 5A shows an impulse response from a magnetic head slider according to a comparative example. FIG. 5B shows the frequency characteristics (relative comparisons based on a slider vibration of 0 dB at FH=15 nm) of vibration of the magnetic head slider 16 according to the present embodiment with FH continuously reduced using the FH adjustment mechanism.

FIGS. 5A and 5B indicate that the magnetic head slider 16 according to the comparative example has no vibrational resonance point exceeding 100 kHz, whereas the air film generated by the magnetic head slider 16 (negative pressure slider) according to the present embodiment has a resonant frequency of between about 100 and 300 kHz. The resonance of the air film is expected to be effectively suppressed by a reduction in microwaviness with frequencies covering the entire range of the resonant frequency (between 100 and 300 kHz), that is, the microwaviness corresponding to the band of the resonant frequency (between 100 and 300 kHz), while the disk is rotating. Here, in the data area 10a of the magnetic disk 10, during rotation, the magnetic disk 10 exhibits the lowest peripheral speed at the innermost peripheral portion of the disk and the highest peripheral speed at the outermost peripheral portion of the disk. The use of this relationship enables determination of the wavelength band of waviness to be reduced in order to suppress resonance of the air film.

Specifically, waviness with a wavelength band defined by wavelengths λ1 and λ2 calculated by Expressions (1) and (2) shown below is sufficiently reduced. In Expressions (1) and (2), Rid means the radius [m] of the innermost periphery 11a of the data area. Rod means the radius [m] of the outermost periphery 11b of the data area. RPS means a rotational speed used [rps].

λ1=2×π×Rid×RPS/300000 (1)

λ2=2×π×Rod×RPS/100000 (2)

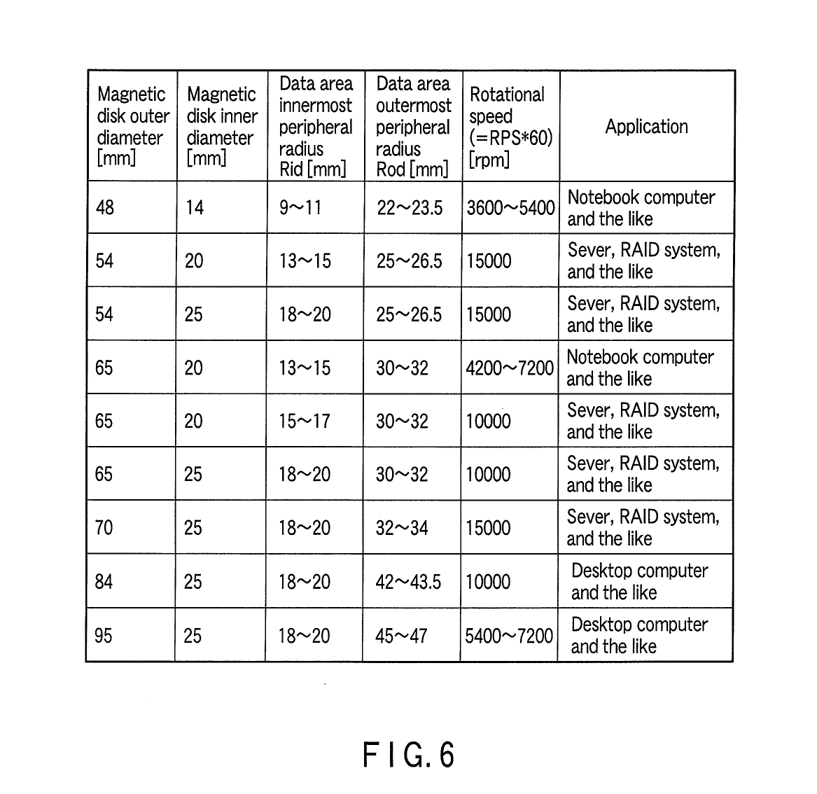

Here, for example, such values as shown in the table in FIG. 6 are used as the values (Rid, Rod, RPS).

Now, experiments for determining the degree to which waviness with a wavelength of between λ1 and λ2 is reduced will be described.

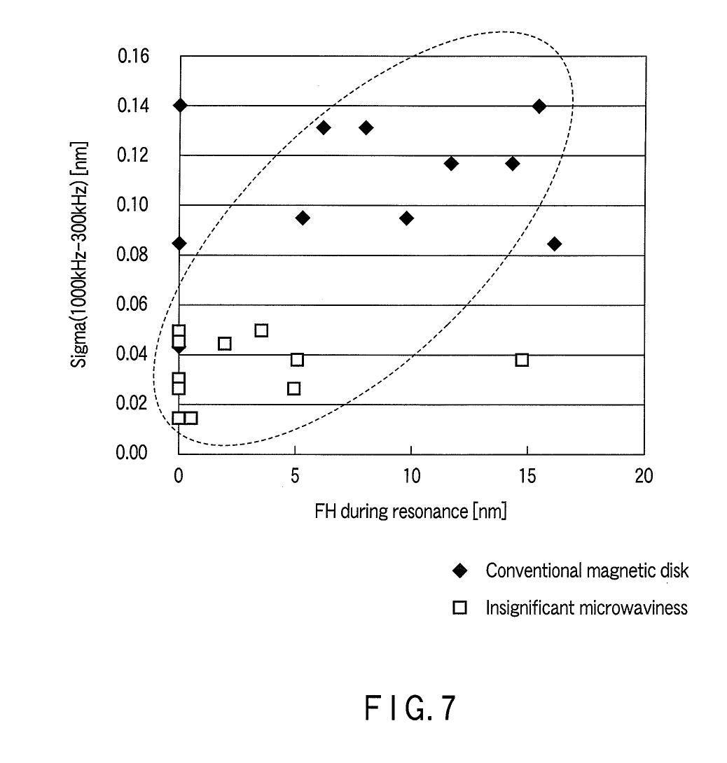

FIG. 7 is a diagram showing the relationship between the FH during resonance of the magnetic head slider 16 and the standard deviation value (sigma value) of waviness of the magnetic disk 10. Here, the sigma value of waviness of the magnetic disk was obtained, specifically, by using the laser measuring instrument to measure the surface shape of the magnetic disk and then applying a band-pass filter to the resultant surface shape at a band of between 100 and 300 kHz. Furthermore, in the measurement, various radial positions and rotational speeds are set.

As can be seen in FIG. 7, the FH during resonance is reduced (to at most about 10 nm) when the sigma value of microwaviness defined by a wavelength band of between λ1 and λ2 is about 0.05 nm. Thus, in the present embodiment, the sigma value of microwaviness with a wavelength band defined by a wavelength of between λ1 and λ2 is set to at most about 0.05 nm.

As described above, the present embodiment adopts a magnetic disk in which microwaviness with a wavelength band defined by a wavelength of between λ1 and λ2 has a sigma value set to at most about 0.05 nm, based on the above-described experimental results. Additionally, waviness with a wavelength of at most λ1 preferably has an appropriate magnitude to prevent a possible increase in the magnitude of adsorption friction.

Here, in general, the flatness of the surface of the magnetic disk 10 directly reflects the microwaviness of the disk substrate of the magnetic disk 10. Thus, to allow manufacture of the magnetic disk 10 with reduced microwaviness as described above, a substrate with reduced microwaviness needs to be manufactured. A method for manufacturing a substrate (in this case, a glass substrate) with reduced microwaviness will be described.

First, a bored circular glass plate (blank medium) is prepared and subjected to chamfering of the corners and crude processing such as lapping. Thus, a rough flatness is realized. At this time, slurry containing a polishing agent such as SiC or Al₂O₃ is generally used for lapping.

Then, cerium oxide slurry and colloidal silica slurry, and the like are used to polish the recording surface. Here, parameters to be controlled in order to reduce waviness include a material for slurry particles, the particle size of the slurry, the temperature of the slurry, the type of polishing pads, pressure, and speed.

After the polishing step, the substrate is washed and chemically enhanced so as to increase the mechanical strength of the substrate surface. This process allows the glass substrate with reduced microwaviness to be completed. The above-described method for manufacturing the substrate is an example of a method for manufacturing a glass substrate. Thus, the method for manufacturing the glass substrate according to the present embodiment is not limited to the above-described one. Furthermore, a substrate other than the glass substrate may be used. In this case, a manufacturing method may be adopted which is suitable for a material used.

Subsequently, the glass substrate manufactured as described above is used to manufacture a magnetic disk as is the case with the conventional art. Then, a magnetic disk with reduced waviness can be obtained.

As described above in detail, the present embodiment provides the magnetic disk 10 in which the sigma value of microwaviness with a wavelength band defined by a wavelength of between λ1 and λ2 calculated by Expressions (1) and (2) described above is set to at most about 0.05 nm. Thus, the rotational speed of the magnetic disk and the resonant frequency of the air film generated by the magnetic head slider are taken into account to allow the resonance of the air film generated by the magnetic head slider to be effectively suppressed. Hence, the HDD 100 comprising the magnetic disk 10 is not or not substantially affected by resonance and can accurately record and reproduce data. The present embodiment can thus provide a magnetic storage medium and a magnetic storage device both configured to suppress the resonance of the air film generated by the magnetic head slider to enable data to be accurately recorded and reproduced.

As shown in FIG. 3B, the above-described embodiment adopts the wavelength range determined by Expressions (1) and (2) described above, as the wavelength range corresponding to a frequency of between 100 and 300 kHz which covers almost all of the frequency range in which resonance occurs. However, the present invention is not limited to this configuration. That is, clearly, microwaviness can be more effectively reduced based on the resonant frequency of the magnetic head slider. Thus, λ1 and λ2 can be set in accordance with the resonant frequency of the magnetic head slider. Specifically, if the resonant frequency of the magnetic head slider is known to be fr, Expressions (3) and (4) shown below may be used. Here, the value Δfr means the frequency ranges before and after fr and is determined for each device. For example, Δfr can be set to about 10,000 to 20,000 (Hz).

λ1=2×π×Rid×RPS/(fr+Δfr) (3)

λ2=2×π×Rod×RPS/(fr+Δfr) (4)

Furthermore, in the above-described embodiment, the wavelength range of microwaviness to be reduced is defined for the entire surface of the disk. However, the wavelength range of microwaviness to be reduced may be defined for each track radius position. In this case, each track radius (Rd) may be substituted into:

λ1=2×π×Rd×RPS/300000 (5)

λ2=2×π×Rd×RPS/100000 (6)

As is the case with Expressions (3) and (4) described above, if the resonant frequency fr is used, Expressions (7) and (8) may be used.

λ1=2×π×Rd×RPS/(fr+Δfr) (7)

λ2=2×π×Rd×RPS/(fr+Δfr) (8)

Alternatively, the wavelength range of microwaviness to be reduced may be defined for each zone. In this case, the central radius of the zone may be used to determine λ1 and λ2 for each zone based on Expressions (5) and (6) or (7) and (8) described above. Alternatively, the innermost and outermost peripheral radii of the zone may be used to determine λ1 and λ2 for each zone based on Expressions (1) and (2) described above.

In the above-described embodiment, the mechanism comprising the heater is adopted as an FH adjustment mechanism. However, the present invention is not limited to this configuration. Various other mechanisms can be adopted provided that the mechanism can adjust the distance between the magnetic head and the magnetic disk.

While certain embodiments of the invention have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit to the inventions.

What is claimed is:

1. A magnetic storage medium comprising a data area configured to store data, the data area comprising an innermost peripheral radius Rid [m] and an outermost peripheral radius Rod [m],
wherein micro-waviness with a wavelength in a range between λ1 and λ2 is set to at most 0.05 nm in terms of a standard deviation value (sigma value), where
λ1=2×π×Rid×RPS/300,000,
λ2=2×π×Rod×RPS/100,000,
and RPS [rps] is a rotational speed during recording and reproduction of the data.

2. A magnetic storage medium comprising a data area in and from which a magnetic head on a magnetic head slider configured to generate an air film with a resonant frequency fr [Hz] records and reproduces data, the data area comprising an innermost peripheral radius Rid [m] and an outermost peripheral radius Rod [m],
wherein waviness with a wavelength in a range between λ1 and λ2 is set to at most 0.05 nm in terms of a standard deviation value (sigma value) where
λ1=2×π×Rid×RPS/(fr+Δfr),
λ2=2×π×Rod×RPS/(fr−Δfr),
RPS [rps] is a rotational speed during recording and reproduction, and Δfr [Hz] is a bandwidth of a resonant frequency.

3. A magnetic storage medium comprising a data area comprising a plurality of tracks and configured to store data,
wherein a radius Rd [m] of a track is used for determining a first wavelength λ1 and a second wavelength λ2, where
λ1=2×π×Rd×RPS/300,000,
λ2=2×π×Rd×RPS/100,000,
and RPS [rps] is a rotational speed during recording and reproduction of the data, and
micro-waviness of the track with a wavelength in a range between λ1 and λ2 is set to at most 0.05 nm in terms of a standard deviation value (sigma value).

4. A magnetic storage medium comprising a data area configured to be read by a magnetic head on a magnetic head slider or to be written by the magnetic head on the magnetic head slider, the magnetic head slider configured to generate an air film with a resonant frequency fr [Hz], the data area comprising a plurality of tracks,
wherein micro-waviness with a wavelength in a range between λ1 and λ2 is set to at most 0.05 nm in terms of a standard deviation value (sigma value), where
λ1=2×π×Rd×RPS/(fr+Δfr),
λ2=2×π×Rd×RPS/(fr−Δfr),
RPS [rps] is a rotational speed during recording and reproduction, Δfr [Hz] is a bandwidth of a resonant frequency, and a radius Rd [m] of any track.

5. A magnetic storage device comprising:
the magnetic storage medium of claim 1;
a magnetic head configured to record data on the magnetic storage medium and to reproduce data from the magnetic storage medium; and
a magnetic head slider configured to hold the magnetic head and to fly over the magnetic storage medium.

6. The magnetic storage device of claim 5, wherein the magnetic head slider is configured to generate a positive pressure and a negative pressure between the magnetic head slider and the magnetic storage medium while the magnetic storage medium is rotating.

7. A magnetic storage device comprising:
the magnetic storage medium of claim 2;
a magnetic head configured to record data on the magnetic storage medium and to reproduce data from the magnetic storage medium; and
a magnetic head slider configured to hold the magnetic head and to fly over the magnetic storage medium.

8. The magnetic storage device of claim 7, wherein the magnetic head slider is configured to generate a positive pressure and a negative pressure between the magnetic head slider and the magnetic storage medium while the magnetic storage medium is rotating.

9. A magnetic storage device comprising:
the magnetic storage medium of claim 3;
a magnetic head configured to record data on the magnetic storage medium and to reproduce data from the magnetic storage medium; and
a magnetic head slider configured to hold the magnetic head and to fly over the magnetic storage medium.

10. The magnetic storage device of claim 9, wherein the magnetic head slider is configured to generate a positive pressure and a negative pressure between the magnetic head slider and the magnetic storage medium while the magnetic storage medium is rotating.

11. A magnetic storage device comprising:
the magnetic storage medium of claim 4;
a magnetic head configured to record data on the magnetic storage medium and to reproduce data from the magnetic storage medium; and
a magnetic head slider configured to hold the magnetic head and to fly over the magnetic storage medium.

12. The magnetic storage device of claim 11, wherein the magnetic head slider is configured to generate a positive pressure and a negative pressure between the magnetic head slider and the magnetic storage medium while the magnetic storage medium is rotating.
